(19) United States
(12) Patent Application Publication
(10) Pub. No.: US 2018/0236671 A1
(43) Pub. Date: Aug. 23, 2018

(54) ROBOT

(71) Applicant: Seiko Epson Corporation, Tokyo (JP)

(72) Inventors: Kazuto YOSHIMURA, Matsumoto (JP); Kazushige AKAHA, Azumino (JP); Sho NAKANO, Matsumoto (JP); Yoshinobu GOTO, Matsumoto (JP)

(21) Appl. No.: 15/896,398

(22) Filed: Feb. 14, 2018

(30) Foreign Application Priority Data
Feb. 21, 2017 (JP) 2017-029699

(51) Int. Cl. B25J 19/00

(52) U.S. Cl. CPC B25J 19/0029

(57) ABSTRACT

A robot includes a robot arm that has an nth arm (n is an integer of 1 or greater) and an (n+1)th arm disposed in the nth arm so as to be pivotable around an (n+1)th pivot axis, and a motor unit that drives the (n+1)th arm. Each of the nth arm and the (n+1)th arm has a cover. A wire is disposed between the motor and the cover of the nth arm. A non-contact seal structure is formed using the cover of the nth arm and the cover of the (n+1)th arm.

### BACKGROUND

### 1. Technical Field

The present invention relates to a robot.

### 2. Related Art

A robot is known which includes a base and a robot arm having a plurality of arms (links). One arm of two adjacent arms of the robot arm is pivotably linked with the other arm via a joint portion, and the arm located on the most proximal side (most upstream side) is pivotably linked with the base via the joint portion. The joint portion is driven using a motor, and the arm is caused to pivot by driving the joint portion. For example, as an end effector, a hand is detachably mounted on the arm located on the most distal side (most downstream side). For example, the robot grips an object with the hand, moves the object to a predetermined place, and carries out predetermined work such as assembly work.

As this robot, JP-A-2010-284777 discloses a vertically articulated robot which includes a base and a robot arm having a plurality of arms, and in which a cable is disposed in a U-shape in a joint portion. In this robot, in the joint portion, the cable is fixed to each of an upper bottom portion (rotating portion) and a lower bottom portion (stationary portion). The cable is disposed in the U-shape between an annular upper bottom side guide portion fixed to the upper bottom portion and an annular lower bottom side guide portion fixed to the lower bottom portion, thereby securing a movable range of a joint of the robot. The upper bottom side guide portion rotates relative to the lower bottom side guide portion. Accordingly, there is a gap between the upper bottom side guide portion and the lower bottom side guide portion. The cable is usually coated with grease in order to reduce frictional resistance therebetween.

However, according to the robot disclosed in JP-A-2010-284777, there is the gap between the upper bottom side guide portion (cover) and the lower bottom side guide portion (cover). Accordingly, if the arm pivots and the cable is moved, there is a possibility that the grease or foreign substances such as abrasion powder of the cable may leak out from the gap. If there is the gap, there is a possibility that the foreign substances may be mixed into the robot arm from outside via the gap.

### SUMMARY

An advantage of some aspects of the invention is to solve at least a part of the problems described above, and the invention can be implemented as the following forms or application examples.

A robot according to an aspect of the invention includes a robot arm that has an nth arm (n is an integer of 1 or greater) and an (n+1)th arm disposed in the nth arm so as to be pivotable around an (n+1)th pivot axis, and a motor that drives the (n+1)th arm. Each of the nth arm and the (n+1)th arm has a cover. A wire is disposed between the motor and the cover of the nth arm. A non-contact seal structure is formed using the cover of the nth arm and the cover of the (n+1)th arm.

In the robot according to the aspect of the invention, in a case where the robot arm is driven, a grease inside the robot arm or foreign substances such as abrasion powder generated inside the robot arm can be restrained from leaking out from between the cover of the nth arm and the cover of the (n+1)th arm. The foreign substances can be restrained from being mixed into the robot arm from between the cover of the nth arm and the cover of the (n+1)th arm.

In the robot according to the aspect of the invention, it is preferable that the non-contact seal structure is a labyrinth structure.

With this configuration, the grease inside the robot arm or the foreign substances such as the abrasion powder generated inside the robot arm can be more accurately restrained from leaking out from between the cover of the nth arm and the cover of the (n+1)th arm. The foreign substances can be more accurately restrained from being mixed into the robot arm from between the cover of the nth arm and the cover of the (n+1)th arm.

In the robot according to the aspect of the invention, it is preferable that the non-contact seal structure has a gap formed between the cover of the nth arm and the cover of the (n+1)th arm. It is preferable that in a cross section taken along the (n+1)th pivot axis, the gap has a first gap which extends in a direction intersecting an axial direction of the (n+1)th pivot axis and a second gap which extends in a direction intersecting the extending direction of the first gap and which communicates with the first gap.

With this configuration, the grease inside the robot arm or the foreign substances such as the abrasion powder generated inside the robot arm can be more accurately restrained from leaking out from between the cover of the nth arm and the cover of the (n+1)th arm. The foreign substances can be more accurately restrained from being mixed into the robot arm from between the cover of the nth arm and the cover of the (n+1)th arm.

In the robot according to the aspect of the invention, it is preferable that at least any one of the cover of the nth arm and the cover of the (n+1)th arm has a recess which is recessed in the direction intersecting the axial direction of the (n+1)th pivot axis.

With this configuration, the grease can be accumulated in the recess, and the lubricant can be more accurately restrained from leaking out.

In the robot according to the aspect of the invention, it is preferable that the recess is located inside the non-contact seal structure.

With this configuration, the grease can be accumulated in the recess, and the lubricant can be more accurately restrained from leaking out.

In the robot according to the aspect of the invention, it is preferable that the non-contact seal structure internally has a grease.

With this configuration, at least a portion of the gap formed between the cover of the nth arm and the cover of the (n+1)th arm can be blocked using the grease. The foreign substances such as the abrasion powder generated inside the robot arm can be more accurately restrained from leaking out. The foreign substances can be more accurately restrained from being mixed into the robot arm from between the cover of the nth arm and the cover of the (n+1)th arm.

In the robot according to the aspect of the invention, it is preferable that the penetration of the grease is in a range from 150 to 300.

With this configuration, the grease can obtain proper hardness. According to this configuration, the grease disposed inside the non-contact seal structure can be restrained from leaking out.

In the robot according to the aspect of the invention, it is preferable that the non-contact seal structure internally has an absorbing material capable of absorbing the grease.

With this configuration, the grease inside the robot arm can be absorbed by the absorbing material, and the lubricant can be more accurately restrained from leaking out. At least a portion of the gap formed between the cover of the nth arm and the cover of the (n+1)th arm by the lubricant absorbed using the absorbing material. The foreign substances such as the abrasion powder generated inside the robot arm can be more accurately restrained from leaking out. The foreign substances can be more accurately restrained from being mixed into the robot arm from between the cover of the nth arm and the cover of the (n+1)th arm.

In the robot according to the aspect of the invention, it is preferable that the nth arm is pivotable around an nth pivot axis (n is an integer of 1 or greater). It is preferable that the axial direction of the (n+1)th pivot axis is different from the axial direction of the nth pivot axis. It is preferable that when viewed in the axial direction of the (n+1)th pivot axis, the nth arm and the (n+1)th arm overlap each other.

With this configuration, it is possible to minimize a space for preventing the robot from interfering with the distal end of the robot arm in a case where the distal end of the robot arm is moved to a position different as large as 180° around the nth pivot axis.

In the robot according to the aspect of the invention, it is preferable that a length of the nth arm is longer than a length of the (n+1)th arm.

With this configuration, when viewed in the axial direction of (n+1)th pivot axis, the nth arm and the (n+1)th arm can easily overlap each other. According to this configuration, it is possible to minimize the space for preventing the robot from interfering with the distal end of the robot arm in a case where the distal end of the robot arm is moved to a position different as large as 180° around the nth pivot axis.

In the robot according to the aspect of the invention, it is preferable that the nth arm (n is 1) is disposed in a base.

With this configuration, the nth arm can pivot around the base.

In the robot according to the aspect of the invention, it is preferable that the robot arm has an (n+2)th arm which is disposed in the (n+1)th arm so as to be pivotable around an (n+2)th pivot axis. It is preferable that the robot arm has a guide disposed in the (n+2)th arm so as to guide the wire.

With this configuration, in a case where the robot arm is driven, the wire can be restrained from being caught on the robot arm.

In the robot according to the aspect of the invention, it is preferable that an end effector is disposed in a distal end of the robot arm. It is preferable that the wire is electrically connected to the end effector.

With this configuration, the control device for controlling the driving of the end effector by using the wire can be electrically connected to the end effector. Accordingly, the control device can control the driving of the end effector.

In the robot according to the aspect of the invention, it is preferable that the wire is supported by a coil spring disposed in the guide.

With this configuration, in a case where the robot arm is driven and the wire is pulled, the coil spring is elastically deformed in response to the pulled wire. According to this configuration, the driving of the robot arm can be restrained from being hindered by the wire, or the wire can be restrained from being broken.

In the robot according to the aspect of the invention, it is preferable that the robot arm has an (n+3)th arm disposed in the (n+2)th arm so as to be pivotable around an (n+3)th pivot axis. It is preferable that the axial direction of the (n+3)th pivot axis is different from the axial direction of the (n+2)th pivot axis. It is preferable that the guide portion has a plate-shaped portion disposed along the (n+3)th pivot axis.

With this configuration, in a case where the robot arm is driven, the wire can be more accurately restrained from being caught on the robot arm.

### BRIEF DESCRIPTION OF THE DRAWINGS

The invention will be described with reference to the accompanying drawings, wherein like numbers reference like elements.

FIG. 1 is a perspective view illustrating a first embodiment of a robot (robot system) according to the invention.

FIG. 2 is a schematic view of the robot illustrated in FIG. 1.

FIG. 3 is a side view of the robot illustrated in FIG. 1.

FIG. 4 is a front view of the robot illustrated in FIG. 1.

FIG. 5 is a front view of the robot illustrated in FIG. 1.

FIG. 6 is a block diagram of the robot (robot system) illustrated in FIG. 1.

FIG. 7 is a view for describing a cable arrangement of the robot illustrated in FIG. 1.

FIG. 8 is a sectional view illustrating a non-contact seal structure portion of the robot illustrated in FIG. 1.

FIG. 9 is a sectional view illustrating a non-contact seal structure portion in a second embodiment of the robot according to the invention.

FIG. 10 is a sectional view illustrating a non-contact seal structure portion in a third embodiment of the robot according to the invention.

FIG. 11 is a sectional view illustrating a non-contact seal structure portion in a fourth embodiment of the robot according to the invention.

FIG. 12 is a sectional view illustrating a non-contact seal structure portion in a fifth embodiment of the robot according to the invention.

FIG. 13 is a perspective view illustrating a sixth embodiment of the robot (robot system) according to the invention.

FIG. 14 is a side view of the robot illustrated in FIG. 13.

FIG. 15 is a perspective view illustrating a seventh embodiment of the robot according to the invention.

FIG. 16 is a front view of the robot illustrated in FIG. 15.

### DESCRIPTION OF EXEMPLARY EMBODIMENTS

Hereinafter, a robot according to the invention will be described in detail with reference to embodiments illustrated in the accompanying drawings.

In the following embodiments, a case where n is 1 defined in the appended claims will be described as an example. However, n may be an integer of 1 or greater.

### First Embodiment

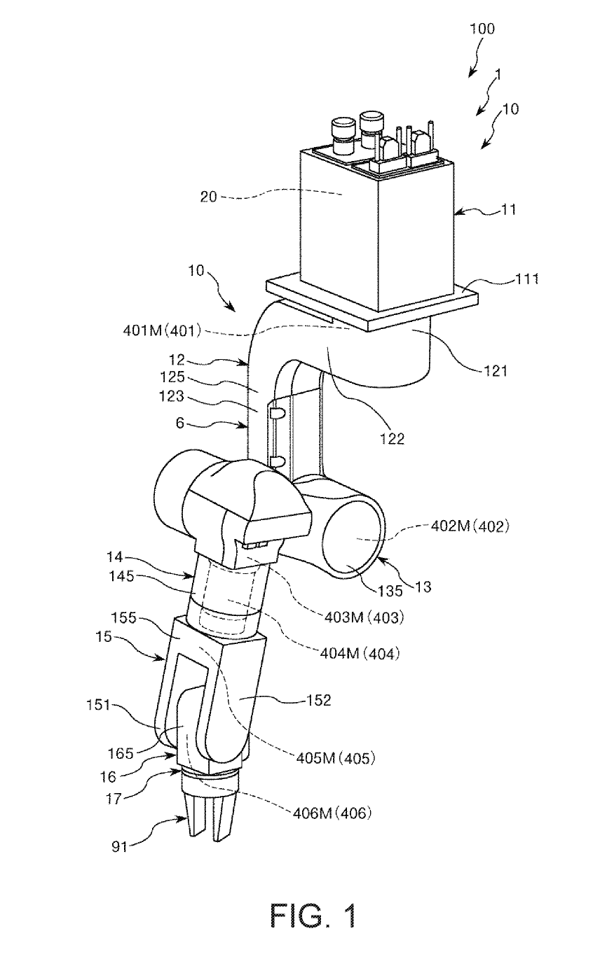

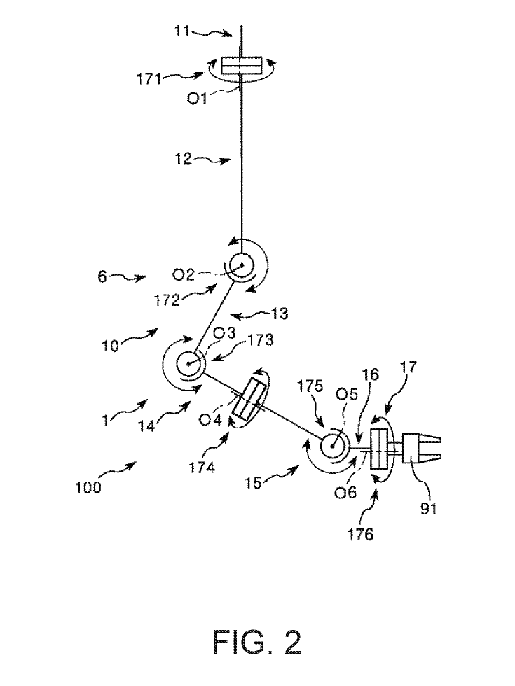

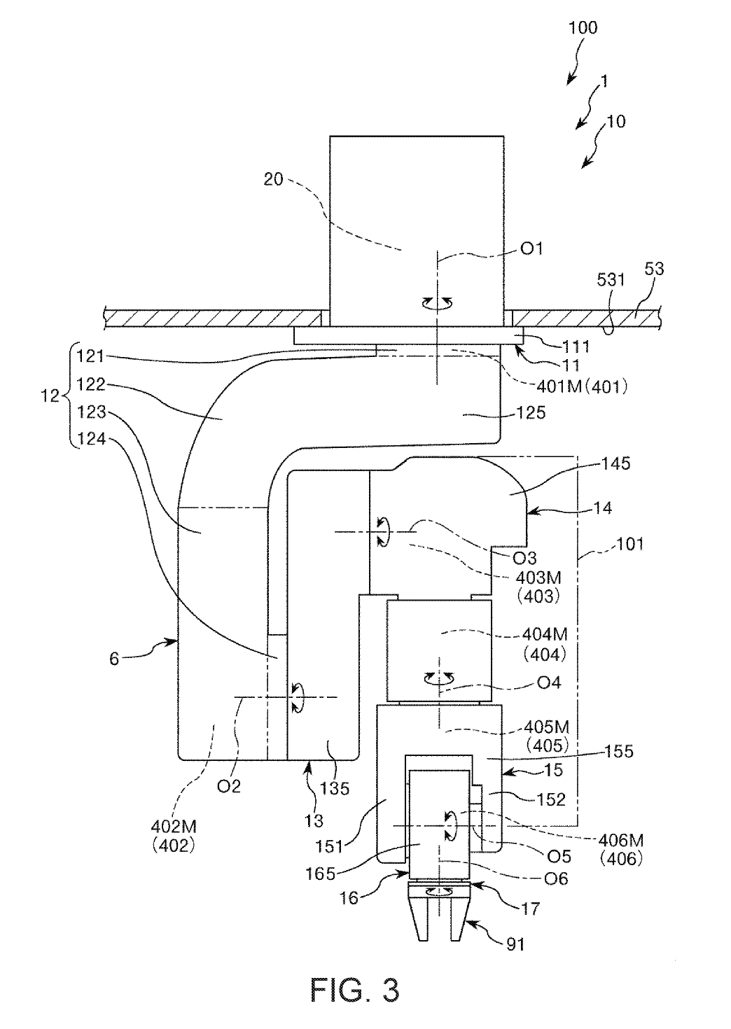

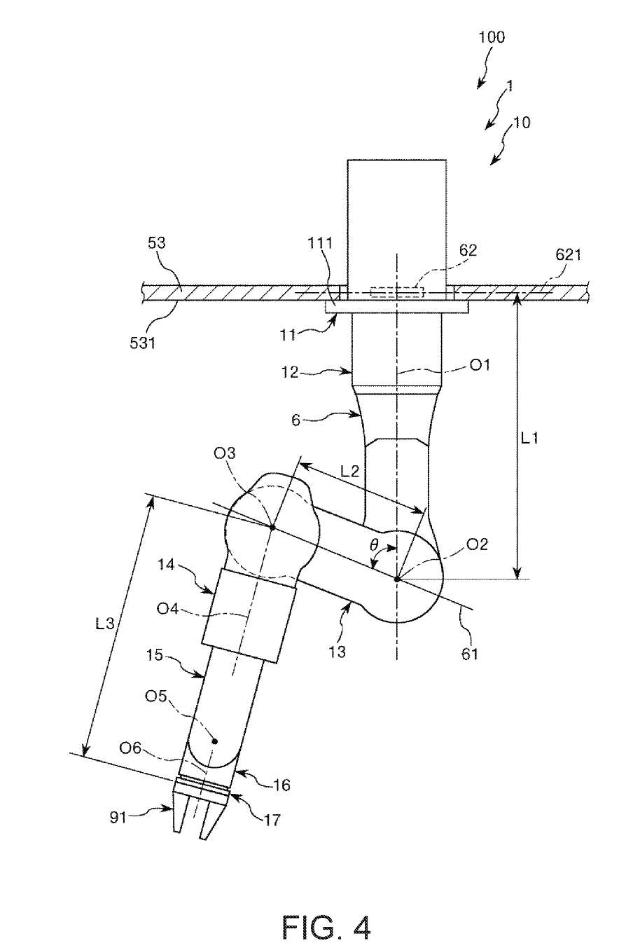

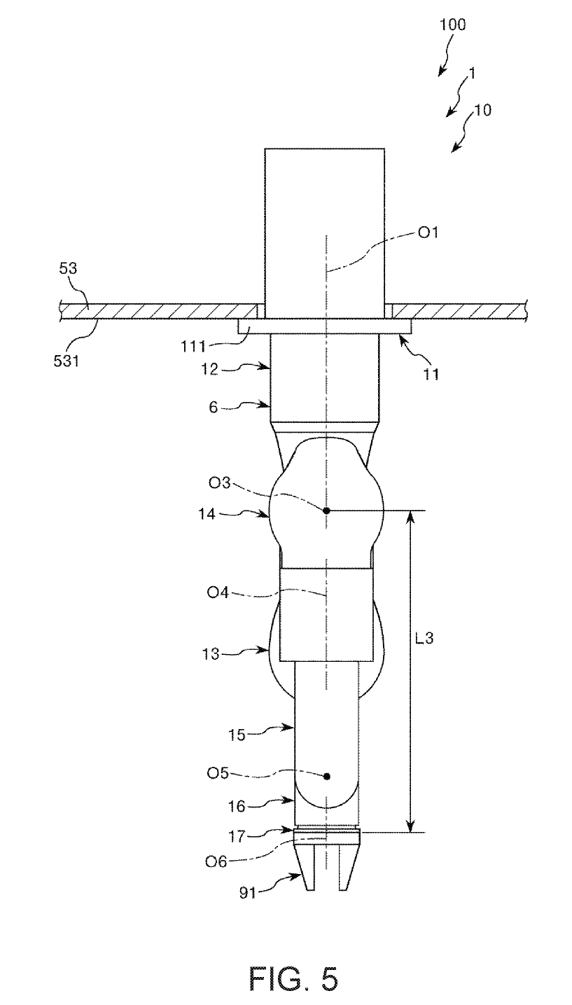

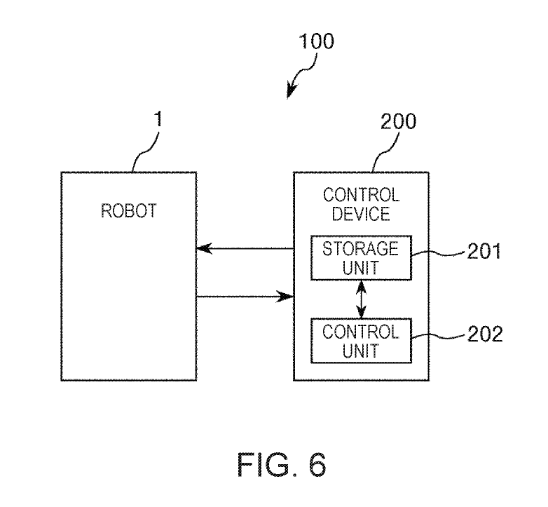

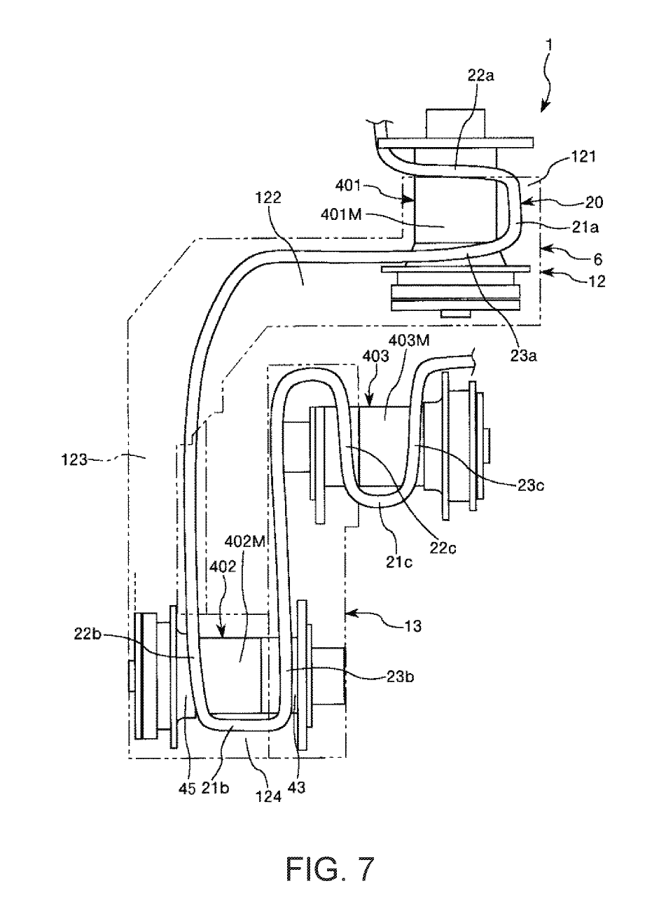

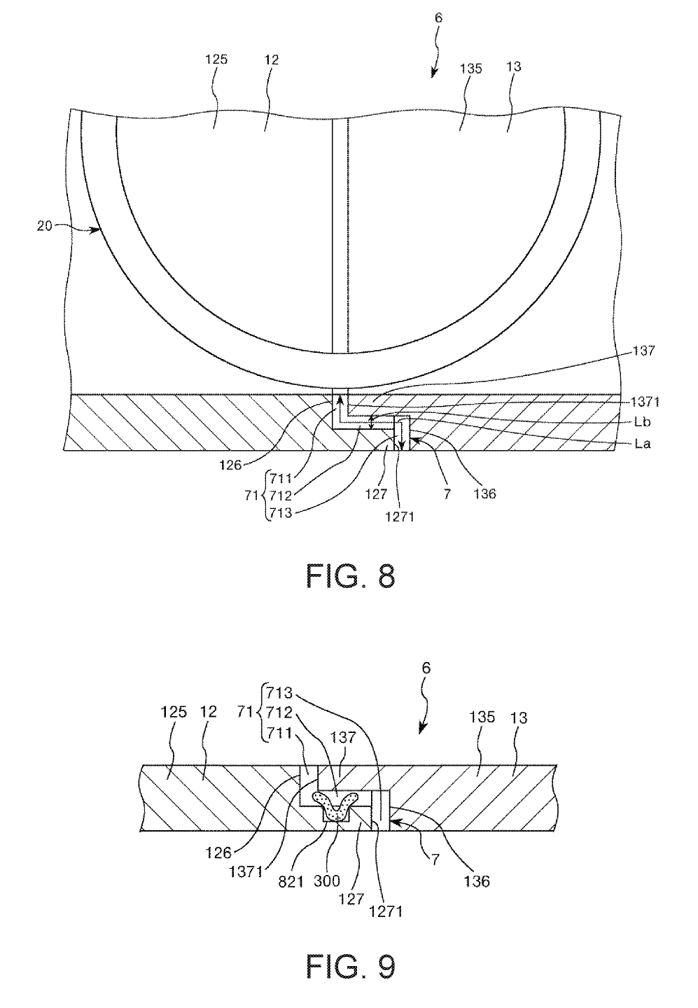

FIG. 1 is a perspective view illustrating a first embodiment of a robot (robot system) according to the invention. FIG. 2 is a schematic view of the robot illustrated in FIG. 1. FIG. 3 is a side view of the robot illustrated in FIG. 1. FIG. 4 is a front view of the robot illustrated in FIG. 1. FIG. 5 is a front view of the robot illustrated in FIG. 1. FIG. 6 is a block diagram of the robot (robot system) illustrated in FIG. 1. FIG. 7 is a view for describing a cable arrangement of the robot illustrated in FIG. 1. FIG. 8 is a sectional view illustrating a non-contact seal structure portion of the robot illustrated in FIG. 1.

For convenience of description, an upper side in FIGS. 1 and 3 to 5 will be referred to as “up” or “upward”, and a lower side will be referred to as “down” or “downward”. A base side in FIGS. 1 to 5 will be referred to as “proximal end” or “upstream”, and a side opposite thereto (hand side) will be referred to as a “distal end” or “downstream”. An upward/downward direction in FIGS. 1 and 3 to 5 will be referred as a “perpendicular direction”, and a rightward/leftward direction will be referred to as a “horizontal direction”. In the description herein, the term “horizontal” includes not only a case of being completely horizontal, but also a case of being inclined within a range of ±5° with respect to the horizontal. Similarly, in the description herein, the term “perpendicular” includes not only a case of completely perpendicular, but also a case of being inclined within a range of ±5° with respect to the perpendicular. In the description herein, “parallel” includes not only a case where two lines (including axes) or planes are completely parallel to each other, but also a case where one is inclined within a range of ±5° with respect to the other one. In the description herein, “orthogonal” includes not only a case where two lines (including axes) or planes are completely orthogonal to each other, but also a case where one is inclined within a range of ±5° with respect to the other one. A lateral direction in FIG. 8 coincides with an axial direction of a second pivot axis O2. The same applies to the drawings of the other embodiments.

As illustrated in FIGS. 1 to 3 and 6, a robot system 100 (industrial robot system) includes a robot 1 (industrial robot) and a control device 200 (robot control device) for controlling the robot 1. For example, the robot system 100 can be used for a manufacturing process of manufacturing precision instruments such as wristwatches. For example, the robot system 100 can carry out each work such as supplying, removing, transporting, and assembling the precision instruments or components configuring the precision instruments. In the invention, the robot 1 may have the control device 200.

The control device 200 includes a control unit 202 for performing each control and a storage unit 201 for storing each information. For example, the control device 200 can be configured to include a personal computer (PC) having an incorporated central processing unit (CPU) (not illustrated), and controls each unit such as a first motor 401M, a second motor 402M, a third motor 403M, a fourth motor 404M, a fifth motor 405M, a sixth motor 406M, and a hand 91 of the robot 1 (to be described later). A program for controlling the robot 1 is stored in the storage unit 201 in advance.

The control device 200 may be partially or entirely incorporated in the robot 1 (robot body 10), or may be a separate body from the robot 1. In the present embodiment, the control device 200 is incorporated in abase 11 (to be described later) of the robot 1.

In a case where the robot 1 and the control device 200 are configured to serve as the separate body, for example, the robot 1 and the control device 200 may be electrically connected to each other using a cable (not illustrated) so as to communicate with each other using a wired system. Alternatively, the cable may be omitted so as to communicate with each other using a wireless system.

The robot 1 includes the robot body 10, a first drive source 401, a second drive source 402, a third drive source 403, a fourth drive source 404, a fifth drive source 405, and a sixth drive source 406. The robot body 10 has the base (support portion) 11 and a robot arm 6.

The robot arm 6 has a first arm 12 disposed in the base 11 so as to be pivotable around a first pivot axis O1, a second arm 13 disposed in the first arm 12 so as to be pivotable around a second pivot axis O2 which is the axial direction different from (in the present embodiment, orthogonal to) the axial direction of the first pivot axis O1 to the first arm 12, a third arm 14 disposed in the second arm 13 so as to be pivotable around a third pivot axis O3, a fourth arm 15 disposed in the third arm 14 so as to be pivotable around a fourth pivot axis O4, a fifth arm 16 disposed in the fourth arm 15 so as to be pivotable around a fifth pivot axis O5, and a sixth arm 17 disposed in the fifth arm 16 so as to be pivotable around a sixth pivot axis O6. The first arm 12, the second arm 13, the third arm 14, the fourth arm 15, and the fifth arm 16 respectively have covers 125, 135, 145, 155, and 165. The first drive source 401, the second drive source 402, the third drive source 403, the fourth drive source 404, the fifth drive source 405, and the sixth drive source 406 are internally disposed therein. A wrist is configured to include the fifth arm 16 and the sixth arm 17. For example, an end effector such as the hand 91 can be detachably attached to a distal end (distal end of the robot arm 6) of the sixth arm 17. Hereinafter, the robot 1 will be described in detail.

A type of the robot 1 is not particularly limited. However, in the present embodiment, the robot 1 is a vertically articulated robot (six axes) in which the base 11, the first arm 12, the second arm 13, the third arm 14, the fourth arm 15, the fifth arm 16, and the sixth arm 17 are linked one with another in this order from the proximal end side toward the distal end side. The “vertically articulated robot” means a robot in which the number of pivot axes (the number of arms) is two or more and two pivot axes of the pivot axes of the robot intersect (are orthogonal to) each other. In the following description, the first arm 12, the second arm 13, the third arm 14, the fourth arm 15, the fifth arm 16, and the sixth arm 17 will be respectively referred to as “arms”. The first drive source 401, the second drive source 402, the third drive source 403, the fourth drive source 404, the fifth drive source 405, and the sixth drive source 406 will be respectively referred to as “drive source”.

As illustrated in FIG. 3, the base 11 is a portion (member to be attached) fixed to (supported by) a predetermined portion of an installation space. This fixing method is not particularly limited. For example, it is possible to employ a fixing method using a plurality of bolts.

In the present embodiment, the base 11 is fixed to a ceiling surface 531 of a ceiling (ceiling portion) 53 of the installation space. The ceiling surface 531 is a plane parallel to a horizontal plane. A plate-shaped flange 111 disposed in the distal end portion of the base 11 is attached to the ceiling surface 531. However, a location of the base 11 attached to the ceiling surface 531 is not limited thereto.

In the robot 1, a connection portion between the base 11 and the robot arm 6, that is, a center line (center) 621 (refer to FIG. 4) of a bearing portion 62 (to be described later) is located above the ceiling surface 531 in the perpendicular direction. The center line 621 of the bearing portion 62 is not limited thereto. For example, the center line 621 may be located below the ceiling surface 531 in the perpendicular direction, or may be located at a position the same as that of the ceiling surface 531 in the perpendicular direction.

In the robot 1, the base 11 is installed on the ceiling surface 531. Accordingly, the connection portion between the first arm 12 and the second arm 13, that is, a center line (center) of a bearing portion (not illustrated) for pivotably supporting the second arm 13 is located below the center line 621 of the bearing portion 62 in the perpendicular direction.

The base 11 may include or may not include a joint 171 (to be described later) (refer to FIG. 2).

The first arm 12, the second arm 13, the third arm 14, the fourth arm 15, the fifth arm 16, and the sixth arm 17 are respectively supported so as to be independently displaceable with respect to the base 11.

As illustrated in FIGS. 1 and 3, the first arm 12 has a curved shape. In a state illustrated in FIG. 3, the first arm 12 has a first portion 121 which is connected to (disposed in) the base 11 and which extends downward in FIG. 3 in the axial direction (perpendicular direction) of the first pivot axis O1 (to be described later) from the base 11, a second portion 122 which extends leftward in FIG. 3 in the axial direction (perpendicular direction) of the second pivot axis O2 from the lower end of the first portion 121 in FIG. 3, a third portion 123 which is disposed an end portion of the second portion 122 opposite to the first portion 121 and which extends downward in FIG. 3 in the axial direction (perpendicular direction) of the first pivot axis O1, and a fourth portion 124 which extends rightward in FIG. 3 in the axial direction (perpendicular direction) of the second pivot axis O2 from an end portion of the third portion 123 opposite to the second portion 122. The first portion 121, the second portion 122, the third portion 123, and the fourth portion 124 are integrally formed. The second portion 122 and the third portion 123 are substantially orthogonal to (intersect) each other when viewed in a direction orthogonal to both the first pivot axis O1 and the second pivot axis O2 (when viewed from a front surface of the drawing in FIG. 3).

The second arm 13 has an elongated shape, and is connected to (disposed in) a distal end portion of the first arm 12, that is, an end portion of the fourth portion 124 opposite to the third portion 123.

The third arm 14 has an elongated shape, and is connected to (disposed in) a distal end portion of the second arm 13, that is, an end portion opposite to the end portion where the second arm 13 is connected to the first arm 12.

The fourth arm 15 is connected to (disposed in) the distal end portion of the third arm 14, that is, the end portion opposite to the end portion where the third arm 14 is connected to the second arm 13. The fourth arm 15 has a pair of support portions 151 and 152 facing each other. The support portions 151 and 152 are used in connecting the fourth arm 15 to the fifth arm 16.

The fifth arm 16 is located between the support portions 151 and 152, and is linked with the fourth arm 15 (disposed in the fourth arm 15) by being connected to the support portions 151 and 152. The fourth arm 15 is not limited to this structure, and for example, the fourth arm 15 may have one support portion (cantilever structure).

The sixth arm 17 has a flat plate shape, and is connected to (disposed in) the distal end portion of the fifth arm 16. In the sixth arm 17, as an end effector, for example, the hand 91 for gripping precision instruments such as wristwatches or components is detachably mounted on the distal end portion (end portion on a side opposite to the fifth arm 16). The driving of the hand 91 is controlled by the control device 200. Without being particularly limited, for example, the hand 91 includes a configuration having a plurality of finger portions (fingers). The robot 1 can carry out various types of work such as transporting the precision instruments or the components by controlling each operation of the arms 12 to 17 while gripping the precision instruments or the components with the hand 91.

As illustrated in FIGS. 1 to 3, the first arm 12 is disposed in the base 11. In this manner, in a case of installing the robot 1, the base 11 is installed. Accordingly, it is possible to easily carry out the installation work.

Specifically, the base 11 and the first arm 12 are linked with each other via a joint 171. The joint 171 has a mechanism for supporting the first arm 12 linked with the base 11 so as to be pivotable with respect to the base 11. In this manner, the first arm 12 is pivotable with respect to the base 11 around the first pivot axis O1 parallel to the perpendicular direction (around the first pivot axis O1). The first pivot axis O1 coincides with a normal line of the ceiling surface 531 of the ceiling 53 to which the base 11 is attached. The first pivot axis O1 is located on the most upstream side of the robot 1. The first arm 12 is caused to pivot around the first pivot axis O1 by driving the first drive source 401 serving as a first drive unit (drive unit) having the first motor 401M and a speed reducer (not illustrated).

It is preferable that a pivot angle of the first arm 12 is set to 90° or smaller. In this manner, even in a case where there is an obstacle around the robot 1, the robot 1 can be easily operated while avoiding the obstacle, and a cycle time can be shortened.

Hereinafter, the first motor 401M, and the second motor 402M, the third motor 403M, the fourth motor 404M, the fifth motor 405M, and the sixth motor 406M (to be described later) will be respectively referred to as “motors”.

The first arm 12 and the second arm 13 are linked with each other via a joint 172. The joint 172 has a mechanism for supporting one of the first arm 12 and the second arm 13 which are linked with each other so as to be pivotable with respect to the other one. In this manner, the second arm 13 is pivotable around the second pivot axis O2 parallel to the horizontal direction (around the second pivot axis O2) with respect to the first arm 12. The second pivot axis O2 is orthogonal to the first pivot axis O1. The second arm 13 is caused to pivot around the second pivot axis O2 by driving the second drive source 402 serving as a second drive unit (drive unit) having the second motor 402M and a speed reducer (not illustrated).

The second pivot axis O2 may be parallel to the axis orthogonal to the first pivot axis O1. The second pivot axis O2 may not be orthogonal to the first pivot axis O1, and the axial directions may be different from each other.

The second arm 13 and the third arm 14 are linked with each other via a joint 173. The joint 173 has a mechanism for supporting one of the second arm 13 and the third arm 14 which are linked with each other so as to be pivotable with respect to the other one. In this manner, the third arm 14 is pivotable around the third pivot axis O3 parallel to the horizontal direction (around the third pivot axis O3) with respect to the second arm 13. The third pivot axis O3 is parallel to the second pivot axis O2. The third arm 14 is caused to pivot around the third pivot axis O3 by driving the third drive source 403 serving as a third drive unit (drive unit) having the third motor 403M and a speed reducer (not illustrated).

The third arm 14 and the fourth arm 15 are linked with each other via a joint 174. The joint 174 has a mechanism for supporting one of the third arm 14 and the fourth arm 15 which are linked with each other so as to be pivotable with respect to the other one. In this manner, the fourth arm 15 is pivotable around the fourth pivot axis O4 parallel to the center axial direction of the third arm 14 (around the fourth pivot axis O4) with respect to the third arm 14 (base 11). The fourth pivot axis O4 is orthogonal to the third pivot axis O3. The fourth arm 15 is caused to pivot around the fourth pivot axis O4 by driving the fourth drive source 404 serving as a fourth drive unit (drive unit) having the fourth motor 404M and a speed reducer (not illustrated).

The fourth pivot axis O4 may be parallel to the axis orthogonal to the third pivot axis O3. The fourth pivot axis O4 may not be orthogonal to the third pivot axis O3, and the axial directions may be different from each other.

The fourth arm 15 and the fifth arm 16 are linked with each other via a joint 175. The joint 175 has a mechanism for supporting one of the fourth arm 15 and the fifth arm 16 which are linked with each other so as to be pivotable with respect to the other one. In this manner, the fifth arm 16 is pivotable around the fifth pivot axis O5 orthogonal to the center axial direction of the fourth arm 15 (around the fifth pivot axis O5) with respect to the fourth arm 15. The fifth pivot axis O5 is orthogonal to the fourth pivot axis O4. The fifth arm 16 is caused to pivot around the fifth pivot axis O5 by driving the fifth drive source 405 serving as a fifth drive unit (drive unit). The fifth drive source 405 has the fifth motor 405M, a speed reducer (not illustrated), a first pulley (not illustrated) linked with a shaft portion of the fifth motor 405M, a second pulley (not illustrated) disposed with a distance from the first pulley and linked with a shaft portion of the speed reducer, and a belt (not illustrated) laid between the first pulley and the second pulley.

The fifth pivot axis O5 may be parallel to the axis orthogonal to the fourth pivot axis O4. The fifth pivot axis O5 may not be orthogonal to the fourth pivot axis O4, and the axial directions may be different from each other.

The fifth arm 16 and the sixth arm 17 are linked with each other via a joint 176. The joint 176 has a mechanism for supporting one of the fifth arm 16 and the sixth arm 17 which are linked with each other so as to be pivotable with respect to the other one. In this manner, the sixth arm 17 is pivotable around the sixth pivot axis O6 (around the sixth pivot axis O6) with respect to the fifth arm 16. The sixth pivot axis O6 is orthogonal to the fifth pivot axis O5. The sixth arm 17 is caused to pivot around the sixth pivot axis O6 by driving the sixth drive source 406 serving as a sixth drive unit (drive unit) having the sixth motor 406M and a speed reducer (not illustrated).

The sixth pivot axis O6 may be parallel to the axis orthogonal to the fifth pivot axis O5. The sixth pivot axis O6 may not be orthogonal to the fifth pivot axis O5, and the axial directions may be different from each other.

In the drive sources 401 to 406, the speed reducers may be respectively omitted. In the arms 12 to 17, brakes (braking devices) for braking the arms 12 to 17 may be respectively disposed, or may be omitted.

The motors 401M to 406M are not particularly limited. For example, the motors 401M to 406M include a servomotor such as an AC servo motor and a DC servo motor.

The respective brakes are not particularly limited, and the respective brakes include an electromagnetic brake.

The motors 401M to 406M of the drive source 401 to 406 or the a speed reducers respectively have a first encoder serving as a first position detection unit for detecting a position of the first arm 12, a second encoder serving as a second position detection unit for detecting a position of the second arm 13, a third encoder serving as a third position detecting unit for detecting a position of the third arm 14, a fourth encoder serving as a fourth position detecting unit for detecting a position of the fourth arm 15, a fifth encoder serving as a fifth position detecting unit for detecting a position of the fifth arm 16, and a sixth encoder serving as a sixth position detecting unit for detecting a position of the sixth arm 17 (none of the encoders is illustrated). The encoders respectively detect rotation angles of rotary shafts of the motors 401M to 406M of the drive sources 401 to 406 or the respective speed reducers.

Hitherto, the configuration of the robot 1 has been briefly described.

Next, a relationship between the first arm 12 and the sixth arm 17 will be described. However, the relationship will be described by changing the expression from various viewpoints. The description will be made considering a state where the third arm 14 to the sixth arm 17 are straightened, that is, a state where all of these are most lengthened, in other words, a state where the fourth pivot axis O4 coincides with the sixth pivot axis O6 or a state that both of these are parallel to each other.

First of all, as the premise, the first arm 12 is disposed in the base 11. In this manner, the first arm 12 is pivotable with respect to the base 11.

The first arm 12 is pivotable around the first pivot axis O1, and the axial direction of the second pivot axis O2 is orthogonal to (different from) the axial direction of the first pivot axis O1.

First, as illustrated in FIG. 4, a length L1 of the first arm 12 is longer than a length L2 of the second arm 13. In this manner, when viewed in the axial direction of the second pivot axis O2, the first arm 12 and the second arm 13 can easily overlap each other.

Here, the length L1 of the first arm 12 represents a distance between the second pivot axis O2 and a center line 621 extending in the rightward/leftward direction in FIG. 4 of a bearing portion 62 which pivotably supports the first arm 12 when viewed in the axial direction of the second pivot axis O2.

The length L2 of the second arm 13 represents a distance between the second pivot axis O2 and the third pivot axis O3 when viewed in the axial direction of the second pivot axis O2.

As illustrated in FIG. 5, a configuration is adopted in which an angle θ formed between the first arm 12 and the second arm 13 can be set to 0° when viewed in the axial direction of the second pivot axis O2. In other words, the configuration is adopted as follows. When viewed in the axial direction of the second pivot axis O2, the first arm 12 and the second arm 13 can overlap each other, that is, the first arm 12 and the second arm 13 can be brought into an overlapping state. In this manner, in a case where the distal end of the robot arm 6 is moved to a position different as large as 180° around the first pivot axis O1, it is possible to minimize a space for preventing the robot 1 from interfering with the distal end of the robot arm 6.

In a case where the angle θ is 0°, that is, in a case where the first arm 12 and the second arm 13 overlap each other when viewed in the axial direction of the second pivot axis O2, the second arm 13 is configured not to interfere with the ceiling surface 531 of the ceiling 53 having the base 11 disposed therein and the second portion 122 of the first arm 12. Similarly, in a case where the proximal end surface of the base 11 is attached to the ceiling surface 531, the second arm 13 is configured not to interfere with the ceiling surface 531 and the second portion 122 of the first arm 12.

Here, the angle θ formed between the first arm 12 and the second arm 13 represents an angle formed between a straight line (central axis of the second arm 13 when viewed in the axial direction of the second pivot axis O2) 61 passing through the second pivot axis O2 and the third pivot axis O3, and the first pivot axis O1 when viewed in the axial direction of the second pivot axis O2.

The first arm 12 is not caused to pivot, and the second arm 13 is caused to pivot. In this manner, the second arm 13 can be brought into a state where the angle θ is 0° when viewed in the axial direction of the second pivot axis O2 (state where the first arm 12 and the second arm 13 overlap each other). Thereafter, the distal end of the second arm 13 can be moved to the position different as large as 180° around the first pivot axis O1. That is, the first arm 12 is not caused to pivot, the second arm 13 is caused to pivot. In this manner, the distal end of the robot arm 6 (the distal end of the sixth arm 17) is moved from the left side position illustrated in FIGS. 1 and 4 to the right side position different as large as 180° around the first pivot axis O1 (position opposite to that in FIG. 1 around the first pivot axis O1) after being brought into a state where the angle θ is 0° (refer to FIG. 5). The third arm 14 to the sixth arm 17 are respectively caused to pivot, if necessary.

When the distal end of the second arm 13 is moved to a position different as large as 180° around the first pivot axis O1 (when the distal end of the robot arm 6 is moved from the left side position to the right side position), the distal end of the second arm 13 and the distal end of the robot arm 6 move on the straight line in the axial direction of first pivot axis O1.

A total length (maximum length) L3 of the third arm 14 to the sixth arm 17 is set to be longer than the length L2 of the second arm 13.

In this manner, when the second arm 13 and the third arm 14 overlap each other as viewed in the axial direction of the second pivot axis O2, the distal end of the sixth arm 17 can be caused to protrude from the second arm 13. In this manner, it is possible to prevent the hand 91 from interfering with the first arm 12 and the second arm 13.

Here, the total length (maximum length) L3 of the third arm 14 to the sixth arm 17 represents a distance between the third pivot axis O3 and the distal end of the sixth arm 17 when viewed in the axial direction of the second pivot axis O2 (refer to FIG. 4). In this case, the third arm 14 to the sixth arm 17 are in a state where the fourth pivot axis O4 and the sixth pivot axis O6 coincide with each other or are parallel to each other as illustrated in FIG. 4.

As illustrated in FIG. 5, the second arm 13 and the third arm 14 are configured so that both of these can overlap each other when viewed in the axial direction of the second pivot axis O2.

That is, the first arm 12, the second arm 13, and the third arm 14 are configured so that all of these overlap each other at the same time when viewed in the axial direction of the second pivot axis O2.

In the robot 1, the relationship is satisfied as described above. In this manner, the first arm 12 is not caused to pivot, and the second arm 13 and the third arm 14 are caused to pivot. Accordingly, the hand 91 can be brought into a state where the angle θ formed between the first arm 12 and the second arm 13 is 0° (state where the first arm 12 and the second arm 13 overlap each other) when viewed in the axial direction of the second pivot axis O2. Thereafter, the hand 91 (distal end of the sixth arm 17) can be moved to the position different as large as 180° around the first pivot axis O1. The robot 1 can be efficiently driven by using this operation, and it is possible to minimize the space for preventing the robot 1 from interfering with the hand 91. In this regard, various advantages can be achieved as will be described last.

As illustrated in FIG. 7, as an elongated flexible member, the robot 1 has a cable 20 internally having a plurality of wires (not illustrated). For example, the wire includes an electric wire. The number of cables 20 is not particularly limited. However, in the present embodiment, the number is one. The number of cables 20 may be two or more.

The cable 20 is disposed in a hollow portion of (inside) the first arm 12, a hollow portion of (inside) the second arm 13, a hollow portion of (inside) the third arm 14, and a hollow portion of (inside) the fourth arm 15 (only the fourth arm 15 is not illustrated). That is, the cable 20 is disposed so as to penetrate each of the hollow portions. The cable 20 has a portion disposed between the drive source (drive unit) and the cover, such as a portion disposed between the second drive source 402 (drive unit) and the cover 125 of the first arm 12 and the cover 135 of the second arm 13. Specifically, the cable 20 has a folding portion 21a, a first portion 22a, and a second portion 23a which are disposed on the outer periphery of the motor 401M, a folding portion 21b, a first portion 22b, and a second portion 23b which are disposed on the outer periphery of the motor 402M, a folding portion 21c, a first portion 22c, and a second portion 23c which are disposed on the outer periphery of the motor 403M, and a folding portion, a first portion, and a second portion (not illustrated) which are disposed on the outer periphery of the motor 404M. Each folding portion is disposed in the cable 20 as described above. Accordingly, the space inside the robot arm 6 can be effectively utilized.

The respective folding portions, first portions, and second portions, and their neighboring configuration are similar. Accordingly, hereinafter, as a representative example, the folding portion 21b, the first portion 22b, and the second portion 23b which are disposed on the outer periphery of the motor 402M will be described.

The folding portion 21b of the cable 20 is disposed by being folded on the outer periphery of the motor 402M in the circumferential direction of the shaft portion (output shaft) of the motor 402M, that is, in the circumferential direction of the second pivot axis O2, and has a U-shape (refer to FIG. 3).

The first portion 22b having an arc shape along the outer periphery of the motor 402M is disposed in one end portion of the folding portion 21b, and the end portion of the first portion 22b is fixed to a support member 45 of the motor 402M by a using a fixing member (not illustrated). The second portion 23b having an arc shape along the outer periphery of the motor 402M is disposed in the other end portion of the folding portion 21b, and the end portion of the second portion 23b is fixed to a pivoting member 43 of the speed reducer which is pivotable with respect to the motor 402M by using a fixing member (not illustrated). The pivoting member 43 is fixed to the second arm 13, and the motor 402M is fixed to the first arm 12. That is, the cable 20 is fixed to the first arm 12 in the end portion of the first portion 22b, and is fixed to the second arm 13 in the end portion of the second portion 23b.

In a case where the motor 402M is driven and the second arm 13 pivots, the pivoting member 43 pivots with respect to the motor 402M. However, at that time, the folding portion 21b is bent and deformed while the twisting is restrained. In this manner, stress acting on the cable 20 is alleviated. That is, a large bending radius of the cable 20 can be secured in the folding portion 21b. In a case where the second arm 13 pivots, it is possible to restrain twisting and breakage of the cable 20. In this manner, damage to the cable 20 can be restrained, and durability can be improved.

The cable 20 is coated with grease which is an example of the lubricant. This grease reduces the frictional resistance of the cable 20, and improves slippage. Accordingly, the abrasion of the cable 20 can be restrained.

The grease is not particularly limited. However, a penetration (worked penetration) of the grease (the lubricant) is preferably 150 or greater and 300 or smaller, more preferably 150 or greater and 260 or smaller, further more preferably 200 or greater and 260 or smaller. In this manner, proper hardness can be obtained for the grease. If the penetration of the grease is greater than the upper limit value, depending on other conditions, the grease may be too soft and unsuitable in some cases. If the penetration of the grease is smaller than the lower limit value, depending on other conditions, the grease may be too hard and unsuitable in some cases.

In the robot 1, a non-contact seal structure is formed by the cover 125 and the cover 135 in a portion between the cover 125 of the first arm 12 and the cover 135 of the second arm 13. Similarly, a non-contact seal structure is formed by the cover 135 and the cover 145 in a portion between the cover 135 of the second arm 13 and the cover 145 of the third arm 14. Similarly, a non-contact seal structure is formed by the cover 145 and the cover 155 in a portion between the cover 145 of the third arm 14 and the cover 155 of the fourth arm 15. The respective non-contact seal structures are similar. Accordingly, hereinafter, as a representative example, the non-contact seal structure formed by the cover 125 of the first arm 12 and the cover 135 of the second arm 13 will be described (the same applies to other embodiments). Hereinafter, the non-contact seal structure formed by the cover 125 and the cover 135 or a portion of the non-contact seal structure will be referred to as a “non-contact seal structure portion”.

Here, the non-contact seal structure represents a structure in which a gap is disposed between the cover 125 and the cover 135 so as to improve liquid-tightness and air-tightness (hermetic sealing performance) by utilizing the gap therebetween.

A form of the non-contact seal structure is not particularly limited. However, the robot 1 employs a labyrinth structure as the non-contact seal structure. That is, the non-contact seal structure is the labyrinth structure in the present embodiment. A distance La (extension length) of a gap 71 extending between the interior and the exterior of the robot arm 6 can be lengthened in the portion between the cover 125 and the cover 135. Therefore, the hermetic sealing performance inside the robot arm 6 can be improved.

The labyrinth structure represents a structure in which an irregular structure is disposed between the cover 125 and the cover 135 so as to form an irregular gap is formed between the cover 125 and the cover 135.

Hereinafter, a non-contact seal structure portion 7 will be described.

First of all, as a premise, the robot 1 has the robot arm 6, and the robot arm 6 has the first arm 12 and the second arm 13 disposed in the first arm 12 so as to be pivotable around the second pivot axis O2. The robot 1 includes the second drive source 402 (motor 402M) which is an example of the drive unit for driving the second arm 13. The first arm 12 has the cover 125, and the second arm 13 has the cover 135. The cable 20 internally having the wire (not illustrated) is disposed between the second drive source 402 (drive unit) and the cover 125 of the first arm 12. The cable 20 is disposed between the second drive source 402 (drive unit) and the cover 135 of the second arm 13. The non-contact seal structure portion 7 (non-contact seal structure) is formed by the cover 125 of the first arm 12 and the cover 135 of the second arm 13 (refer to FIG. 8).

In this manner, in a case where the robot arm 6 is driven, the grease or the foreign substances such as abrasion powder of the cable 20 can be restrained from leaking out from between the cover 125 and the cover 135. The foreign substances can be restrained from being mixed into the robot arm 6 from between the cover 125 and the cover 135. Hereinafter, the description will be made in more detail.

As illustrated in FIG. 8, a rib 127 serving as an example of a protruding portion is formed in an end portion 126 of the cover 125, that is, in a portion of the cover 125 which faces the cover 135. Similarly, a rib 137 serving as an example of a protruding portion is formed in an end portion 136 of the cover 135, that is, inside (inner peripheral side) the rib 127, in a portion of the cover 135 which faces the cover 125. The ribs 127 and 137 respectively protrude in the axial direction of the second pivot axis O2, and are formed over one lap around the second pivot axis O2 around the lap. The rib 137 is disposed inside (inner peripheral side) the rib 127. The rib 137 may be disposed outside (outer peripheral side) the rib 127.

The cover 125 and the cover 135 are disposed in a non-contact state. That is, the rib 127, the rib 137, and the end portion 136 are disposed in a mutually non-contact state. The rib 137 and the end portion 126 are disposed in a mutually non-contact state. In this manner, in a case where the robot arm 6 (robot 1) is driven, it is possible to restrain friction between the cover 125 and the cover 135.

According to this configuration, the gap 71 (clearance) is formed between the cover 125 and the cover 135. That is, the non-contact seal structure portion 7 (non-contact seal structure) has the gap 71 formed between the cover 125 of the first arm 12 and the cover 135 of the second arm 13. In a cross section taken along the second pivot axis O2, the gap 71 has first gaps 711 and 713 extending in the direction intersecting the axial direction of the second pivot axis O2, and a second gap 712 extending in the direction orthogonal to (direction intersecting) the first gaps 711 and 713 and communicating with the first gaps 711 and 713.

Specifically, the gap 71 is configured to include the first gap 711 mainly formed between the end portion 126 and an end portion 1371 of the rib 137, the second gap 712 mainly formed between the rib 127 and the rib 137, and the first gap 713 (third clearance) mainly formed between the end portion 136 and an end portion 1271 of the rib 127. The first gap 711, the second gap 712, and the first gap 713 are arranged in this order from the inside toward the outside of the robot arm 6. The first gap 711 and the second gap 712 communicate with each other, and the second gap 712 and the first gap 713 communicate with each other.

In a cross section taken along the second pivot axis O2 (sectional view illustrated in FIG. 8), the first gap 711 and the first gap 713 respectively extend in the direction orthogonal to (direction intersecting) the axial direction of the second pivot axis O2, that is, in the radial direction. The first gap 711 and the first gap 713 respectively extend over one lap around the second pivot axis O2.

In a cross section taken along the second pivot axis O2, the second gap 712 extends in the direction orthogonal to (direction intersecting) the extending direction of the first gap 711, that is, in the axial direction of the second pivot axis O2. The second gap 712 extends over one lap around the second pivot axis O2.

The non-contact seal structure portion 7 is configured to include the gap 71, the end portion 126, the end portion 136, the rib 127, and the rib 137.

The non-contact seal structure portion 7 having this labyrinth structure is disposed. In this manner, the distance La (extension length) of the gap 71 extending between the inside and the outside of the robot arm 6 is lengthened in the portion between the cover 125 and the cover 135. Accordingly, the hermetic sealing performance inside the robot arm 6 can be improved. That is, according to the non-contact seal structure portion 7, in a case where the robot arm 6 is driven, the grease or the foreign substances such as abrasion powder of the cable 20 can be restrained from leaking out from between the cover 125 and the cover 135. The foreign substances can be restrained from being mixed into the robot arm 6 from between the cover 125 and the cover 135.

The distance La of the gap 71 is not particularly limited, and is appropriately set depending on various conditions. However, the distance La is preferably 3 mm or longer, more preferably 5 mm or longer and 500 mm or shorter, and further more preferably 7 mm or longer and 50 mm or shorter.

If the distance La is greater than the upper limit value, the structure of the non-contact seal structure portion 7 becomes complicated. If the distance La is smaller than the lower limit value, in a case where the robot arm 6 is driven, depending on other conditions, there is a possibility that the grease or the foreign substances such as abrasion powder of the cable 20 may leak out from between the cover 125 and the cover 135.

A distance between the cover 125 and the cover 135 which form (define) the gap 71, that is, a distance Lb (gap length) of the gap 71 is not particularly limited, and is appropriately set depending on various conditions. However, the distance Lb is preferably 5 mm or shorter, more preferably 0.1 mm or longer and 5 mm or shorter, and furthermore preferably 0.1 mm or longer and 3 mm or shorter.

If the distance Lb is greater than the upper limit value, in a case where the robot arm 6 is driven, depending on other conditions, there is a possibility that the grease or the foreign substances such as abrasion powder of the cable 20 may leak out from between the cover 125 and the cover 135. If the distance Lb is smaller than the lower limit value, in a case where the robot arm 6 is driven, depending on other conditions, there is a possibility that friction may occur between the cover 125 and the cover 135.

The distance Lb may be constant along the extending direction of the gap 71, or may be changed. For example, the distance Lb of the first gap 711, the distance Lb of the second gap 712, and the distance Lb of the first gap 713 may be the same as each other, or may be different from each other. The distance Lb of the first gap 711 may be constant along the extending direction of the first gap 711, or may be changed. The distance Lb of the second gap 712 may be constant along the extending direction of the second gap 712, or may be changed. The distance Lb of the first gap 713 may be constant along the extending direction of the first gap 713, or may be changed.

The non-contact seal structure portion 7 (non-contact seal structure) internally has the grease (not illustrated) serving as an example of the lubricant. That is, the gap 71 has the grease. In this manner, at least a portion of the gap 71 is filled with and blocked by the grease. In this manner, in a case where the robot arm 6 is driven, the foreign substances such as abrasion powder of the cable 20 can be restrained from leaking out from between the cover 125 and the cover 135. The foreign substances can be restrained from being mixed into the robot arm 6 from between the cover 125 and the cover 135.

The grease disposed in the gap 71 is not particularly limited, and may be the same as or different from the grease applied to the cable 20.

A method of disposing the grease in the gap 71 is not particularly limited. For example, the robot arm 6 is driven so that the grease applied to the cable 20 is moved to and accumulated in the gap 71. Alternatively, during a manufacturing stage of the robot 1, the grease may be disposed in the gap 71 separately from the cable 20.

The grease disposed in the gap 71 is not particularly limited. However, the penetration (worked penetration) of the grease (lubricant) is preferably 150 or greater and 300 or smaller, more preferably 150 or greater and 260 or smaller, and further more preferably 200 or greater and 260 or smaller. In this manner, proper hardness can be obtained for the grease. In this manner, the leakage of the grease can be restrained.

If the penetration of the grease is greater than the upper limit value, depending on other conditions, the grease may be too soft and unsuitable in some cases. If the penetration of the grease is smaller than the lower limit value, depending on other conditions, the grease may be too hard and unsuitable in some cases.

Next, a conceivable method of setting the dimension of the non-contact seal structure portion 7 will be described.

First, in a case where the non-contact seal structure portion 7 is not disposed, when the robot arm 6 is driven, a leakage amount b that the grease (for example, 4 g) applied to the cable 20 leaks out from a gap (for example, 1 mm) between the cover 125 and the cover 135 is experimentally obtained (for example, b is 0.5 g or less).

In the non-contact seal structure portion 7, a volume of a portion (space) which can hold the grease is set to a. The mass of the grease which can be accumulated in the space of the volume a is (a·ρ), if the density of the grease is set to ρ. It is preferable that that (a·ρ) is greater than b. For example, the density of the grease “Krytox” is 1.93 g/mL.

As described above, according to the robot 1 (robot system 100), the robot 1 includes the non-contact seal structure portion 7. Accordingly, in a case where the robot arm 6 is driven, the grease or the foreign substances such as abrasion powder of the cable 20 can be restrained from leaking out from between the cover 125 and the cover 135. Similarly, the grease or the foreign substances such as abrasion powder of the cable 20 can be restrained from leaking out from between a cover and a cover of other two adjacent arms.

In this manner, it is possible to easily and accurately ensure cleanliness inside a room having the robot 1 installed therein.

The grease can be restrained from leaking out from the non-contact seal structure portion 7. Accordingly, it is unnecessary to strictly control the application amount of the grease to be applied to the cable 20. In this manner, it is possible to reduce the time and labor required for assembling the robot 1.

The robot 1 includes the non-contact seal structure portion 7. Accordingly, the foreign substances can be restrained from being mixed into the robot arm 6 from between the cover 125 and the cover 135. Similarly, the foreign substances can be restrained from being mixed into the robot arm 6 from between a cover and a cover of other two adjacent arms.

As described above, in the robot 1, the first arm 12 is not caused to pivot, and the second arm 13 and the third arm 14 are caused to pivot. In this manner, the distal end of the robot arm 6 can be brought into a state where the angle θ formed between the first arm 12 and the second arm 13 is 0° (state where the first arm 12 and the second arm 13 overlap each other) when viewed in the axial direction of the second pivot axis O2. Thereafter, the distal end of the robot arm 6 can be moved to the position different as large as 180° around the first pivot axis O1.

In this manner, it is possible to minimize the space for preventing the robot 1 from interfering with the distal end of the robot arm 6.

That is, the ceiling 53 can be lowered first. In this manner, the position of the center of gravity of the robot 1 is lowered, and the influence of vibrations of the robot 1 can be reduced. That is, it is possible to restrain the vibrations generated due to a reaction force caused by the operation of the robot 1.

An operable region of the robot 1 in the width direction (direction of the production line) can be reduced. In this manner, the more robots 1 can be arranged per unit length along the production line, and the production line can be shortened.

In a case where the distal end of the robot arm 6 is moved, the movement of the robot 1 can be reduced. For example, the first arm 12 is not caused to pivot, or the pivot angle of the first arm 12 can be minimized. In this manner, a cycle time can be shortened, and work efficiency can be improved.

If an operation to move the distal end of the robot arm 6 to the position different as large as 180° around the first pivot axis O1 (hereinafter, referred to as a “short-cut motion”) is performed by simply causing the first arm 12 to pivot around the first pivot axis O1 as in the robot in the related art, there is a possibility that the robot 1 may interfere with the neighboring wall (not illustrated) or a peripheral device (not illustrated). Consequently, it is necessary to teach the robot 1 an evacuation point for avoiding the interference. For example, in a case where the robot 1 interferes with the wall if only the first arm 12 is rotated as large as 90° around the first pivot axis O1, it is necessary to teach the robot 1 the evacuation point by causing other arms to pivot so as not to interfere with the wall. Similarly, in a case where the robot 1 interferes with the peripheral device, it is necessary to further teach the robot 1 the evacuation point so as not to interfere with the peripheral device. As described above, according to the robot in the related art, it is necessary to teach the robot 1 many evacuation points. Particularly in a case where the space around the robot 1 is small, it is necessary to teach the robot 1 an enormous number of evacuation points. Consequently, it takes efforts and a long time to teach the robot 1 the evacuation points.

In contrast, according to the robot 1, in a case where the short-cut motion is performed, a region or a portion with which the robot 1 may interfere is minimized. Accordingly, the number of evacuation points to be taught can be reduced, and the efforts and the time which are required for teaching the robot 1 the evacuation points can be reduced. That is, according to the robot 1, for example, the number of evacuation points to be taught is reduced to approximately ⅓ of that of the robot in the related art. Therefore, it becomes significantly easy to teach the robot 1 the evacuation points.

A region (portion) 101 surrounded by a two-dot chain line on the right side in FIG. 3 of the third arm 14 and the fourth arm 15 represents a region (portion) in which the robot 1 does not interfere with or is less likely to interfere with the robot 1 itself and other members. Therefore, in a case where a predetermined member is mounted on the region 101, the member is less likely to interfere with the robot 1 and the peripheral device. Therefore, according to the robot 1, the predetermined member can be mounted on the region 101. Particularly in a case where the predetermined member is mounted on the region on the right side in FIG. 3 of the third arm 14 within the region 101, the probability further decreases that the member may interfere with the peripheral device disposed on a work table (not illustrated). Accordingly, this configuration is more effectively adopted.

For example, those which can be mounted on the region 101 includes a hand, a control device for controlling sensor driving of a hand eye camera, or an electromagnetic valve of a suction mechanism.

As a specific example, for example, in a case where the suction mechanism is disposed in the hand, if the electromagnetic valve is installed in the region 101, the electromagnetic valve does not become an obstacle when the robot 1 is driven. In this way, the region 101 is very conveniently used.

In the present embodiment, the number of the ribs 127 and the ribs 137 are respectively one. However, the number is not limited thereto. For example, the number of the ribs 127 and the ribs 137 may be respectively two or more.

According to the present embodiment, the rib 127 and the rib 137 respectively protrude in the axial direction of the second pivot axis O2. However, the configuration is not limited thereto. For example, the rib 127 and the rib 137 may respectively protrude in the direction (the radial direction) orthogonal to the axial direction of the second pivot axis O2.

### Second Embodiment

FIG. 9 is a sectional view illustrating a non-contact seal structure portion in a second embodiment of the robot according to the invention.

Hereinafter, the second embodiment will be described. However, points different from those in the above-described embodiment will be mainly described, and description of similar elements will be omitted.

As illustrated in FIG. 9, in the robot 1 according to the present embodiment, at least one of the cover 125 of the first arm 12 and the cover 135 of the second arm 13 has a groove 821 serving as an example of a recess which is recessed in the direction orthogonal to (intersecting) the axial direction of the second pivot axis O2. In the present embodiment, the cover 125 of the first arm 12 has the groove 821. In this manner, the grease can be accumulated in the groove 821, and the leakage of the grease can be more accurately restrained. Hereinafter, the description will be made in more detail.

The groove 821 (recess) is located inside the non-contact seal structure portion 7 (non-contact seal structure). Specifically, the groove 821 is formed in the rib 127 of the cover 125, and communicates with the second gap 712 of the gap 71. The groove 821 extends over one lap around the second pivot axis O2 (refer to FIG. 3). The groove 821 may be partially disposed without being disposed over one lap.

In this manner, a grease 300 can be accumulated in the groove 821. The groove 821 can be used as follows, for example.

First, when the robot arm 6 is driven and the grease applied to the cable 20 passes through the gap 71, the grease is stopped, thereby restraining the grease from leaking outward.

The grease disposed inside the non-contact seal structure portion 7 is accumulated. In this manner, the leakage of the grease disposed inside the non-contact seal structure portion 7 can be restrained. As described in the first embodiment, the robot arm 6 may be driven so that the grease applied to the cable 20 is moved to and accumulated in the gap 71 or the groove 821. Alternatively, during a manufacturing stage of the robot 1, the grease may be disposed in the gap 71 or the groove 821 separately from the cable 20.

According to the second embodiment as described above, an advantageous effect the same as that according to the above-described embodiment can be achieved.

In the present embodiment, the cover 125 of the first arm 12 has the groove 821. However, the configuration is not limited thereto. For example, the cover 135 of the second arm 13 may have the groove (recess). Alternatively, the covers 125 and 135 may respectively have the groove.

### Third Embodiment

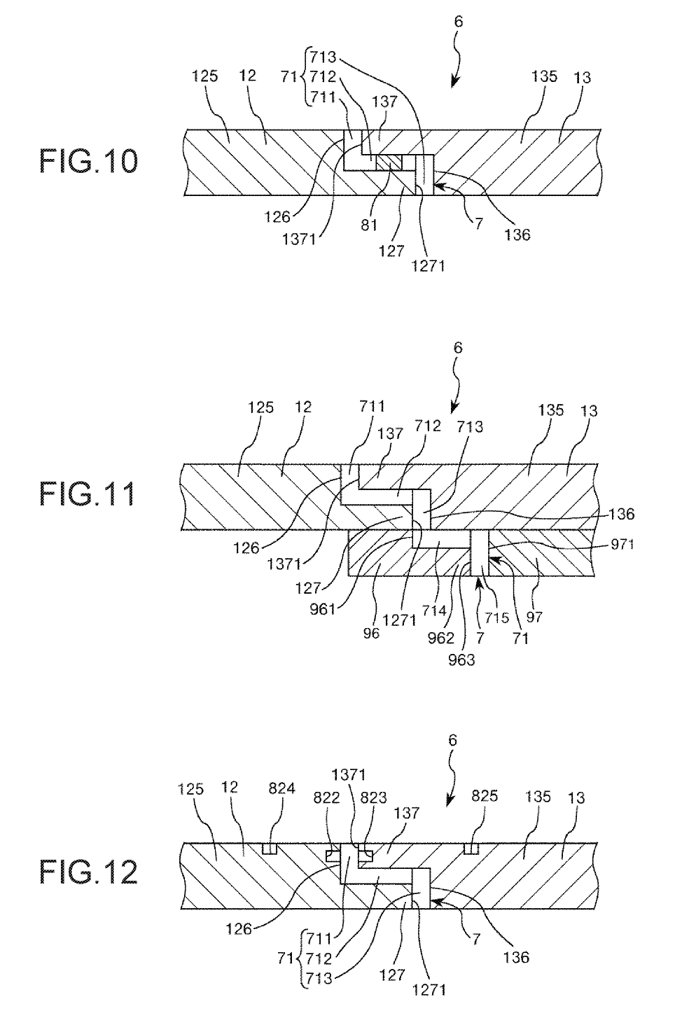

FIG. 10 is a sectional view illustrating a non-contact seal structure portion in a third embodiment of the robot according to the invention.

Hereinafter, the third embodiment will be described. However, points different from those in the above-described embodiments will be mainly described, and description of similar elements will be omitted.

As illustrated in FIG. 10, in the robot 1 according to the present embodiment, the non-contact seal structure portion 7 internally has an absorbing material 81 capable of absorbing the grease (lubricant). Specifically, the absorbing material 81 is disposed in the second gap 712 of the gap 71 of the cover 125 of the first arm 12. The absorbing material 81 extends over one lap around the second pivot axis (refer to FIG. 3). The absorbing material 81 may be partially disposed without being disposed over one lap. In this manner, the grease can be absorbed by and accumulated in the absorbing material 81.

The absorbing material 81 is not particularly limited as long as the absorbing material 81 can absorb the grease. For example, the absorbing material 81 includes a nonwoven fabric.

The absorbing material 81 can be used as follows, for example.

First, when the robot arm 6 is driven and the grease applied to the cable 20 passes through the gap 71, the grease is stopped, thereby restraining the grease from leaking outward.

The grease disposed inside the non-contact seal structure portion 7 is accumulated. In this manner, the leakage of the grease disposed inside the non-contact seal structure portion 7 can be restrained. As described in the first embodiment, the robot arm 6 may be driven so that the grease applied to the cable 20 is moved to and accumulated in the gap 71 or the absorbing material 81. Alternatively, during a manufacturing stage of the robot 1, the grease may be disposed in the gap 71 or the absorbing material 81 separately from the cable 20.

According to the third embodiment as described above, an advantageous effect the same as that according to the above-described embodiments can be achieved.

In the present embodiment, the absorbing material 81 is disposed in the second gap 712 of the gap 71. However, the configuration is not limited thereto. For example, the absorbing material may be disposed in the first gap 711 or the first gap 713. Alternatively, the absorbing material may be disposed in any two or all of the first gap 711, the second gap 712, and the first gap 713.

### Fourth Embodiment

FIG. 11 is a sectional view illustrating a non-contact seal structure portion in a fourth embodiment of the robot according to the invention.

Hereinafter, the fourth embodiment will be described. However, points different from those in the above-described embodiments will be mainly described, and description of similar elements will be omitted.

As illustrated in FIG. 11, in the robot 1 according to the present embodiment, the robot arm 6 has covers 96 and 97 on the outer periphery of the covers 125 and 135. The cover 96 is fixed to the outer periphery of the cover 125, and is disposed in a state where the cover 96 is not in contact with the cover 135. The cover 97 is fixed to the outer periphery of the cover 135, and is disposed in a state where the cover 97 is not in contact with the cover 125.

A rib 962 serving as an example of a protruding portion is formed in an end portion 961 of the cover 96. The rib 962 protrudes in the axial direction of the second pivot axis O2, and is formed over one lap around the second pivot axis O2. The cover 96 and the cover 97 are disposed in a non-contact state. That is, the end portion 961 and the rib 962 of the cover 96, and the end portion 971 of the cover 97 are disposed in a mutually non-contact state. In this manner, in a case where the robot arm 6 (robot 1) is driven, it is possible to restrain friction between the cover 125 and the cover 135.

According to this configuration, the gap 71 (clearance) is formed between the cover 125 and the cover 135. The gap 71 is configured to include a first gap 711, a second gap 712, a first gap 713 (third clearance), a second gap 714 (fourth clearance) mainly formed between the rib 962 and the outer peripheral surface of the cover 135, and a first gap 715 (fifth clearance) mainly formed between an end portion 963 and the end portion 971. The first gap 711, the second gap 712, the first gap 713, the second gap 714, and the first gap 715 are arranged in this order from the inside toward the outside of the robot arm 6. The first gap 711 and the second gap 712 communicate with each other, the second gap 712 and the first gap 713 communicate with each other, the first gap 713 and the second gap 714 communicate with each other, and the second gap 714 and the first gap 715 communicate with each other.

In a cross section taken along the second pivot axis O2 (sectional view illustrated in FIG. 11), the first gap 715 extends in the direction orthogonal to (intersecting) the axial direction of the second pivot axis O2, that is, in the radial direction. The first gap 715 extends over one lap around the second pivot axis O2.

In a cross section taken along the second pivot axis O2, the second gap 714 extends in the direction orthogonal to (intersecting) the extending direction of the first gap 711 (first gap 715), that is, in the axial direction of the second pivot axis O2. The second gap 714 extends over one lap around the second pivot axis O2.

The non-contact seal structure portion 7 is configured to include the gap 71, the end portion 126, the end portion 136, the end portion 961, the end portion 971, the rib 127, the rib 137, and the rib 962.

The non-contact seal structure portion 7 is disposed in this way, the distance La of the gap 71 becomes longer than that of the first embodiment. Accordingly, the hermetic sealing performance inside the robot arm 6 can be further improved.

According to the fourth embodiment as described above, an advantageous effect the same as that according to the above-described embodiments can be achieved.

In the present embodiment, the cover 96 is formed as a member separate from the cover 125. However, the configuration is not limited thereto. For example, the cover 96 and the cover 125 may be formed integrally with each other.

In the present embodiment, the cover 97 is formed as a member separate from the cover 135. However, the configuration is not limited thereto. For example, the cover 97 and the cover 135 may be formed integrally with each other.

For example, one of the cover 96 and the cover 97 may be omitted.

### Fifth Embodiment

FIG. 12 is a sectional view illustrating a non-contact seal structure portion in a fifth embodiment of the robot according to the invention.

Hereinafter, the fifth embodiment will be described. However, points different from those in the above-described embodiments will be mainly described, and description of similar elements will be omitted.

As illustrated in FIG. 12, in the robot 1 according to the present embodiment, the cover 125 of the first arm 12 has a groove 822 serving as an example of a recess which is recessed in the axial direction of the second pivot axis O2, and a groove 824 serving as an example of a recess which is recessed in the direction orthogonal to (intersecting) the axial direction of the second pivot axis O2.

The cover 135 of the second arm 13 has a groove 823 serving as an example of a recess which is recessed in the axial direction of the second pivot axis O2, and a groove 825 serving as an example of a recess which is recessed in the direction orthogonal to (intersecting) the axial direction of the second pivot axis O2.

The groove 822 is located inside the non-contact seal structure portion 7 (non-contact seal structure). Specifically, the groove 822 is formed in the end portion 126 of the cover 125, and communicates with the first gap 711 of the gap 71. The groove 822 extends over one lap around the second pivot axis O2 (refer to FIG. 3). The groove 822 may be partially disposed without being disposed over one lap. In this manner, the grease can be accumulated in the groove 822.

The groove 823 is located inside the non-contact seal structure portion 7 (non-contact seal structure). Specifically, the groove 823 is formed in the end portion 1371 of the rib 137 of the cover 135, and communicates with the first gap 711 of the gap 71. The groove 823 extends over one lap around the second pivot axis O2 (refer to FIG. 3). The groove 823 may be partially disposed without being disposed over one lap. In this manner, the grease can be accumulated in the groove 823.

The groove 824 is formed in the inner peripheral portion of the cover 125, and is open into (communicates with) the robot arm 6. The groove 824 extends over one lap around the second pivot axis O2 (refer to FIG. 3). The groove 824 may be partially disposed without being disposed over one lap. In this manner, the grease can be accumulated in the groove 824.

The groove 825 is formed on the inner periphery of the cover 135 and is open (communicated) to the interior of the robot arm 6. In addition, the groove 825 extends around the second pivot axis O2 (refer to FIG. 3) around the circumference. It should be noted that the groove 825 may be partially provided instead of one lap. In this manner, the groove 825 can store the grease.

According to the fifth embodiment as described above, an advantageous effect the same as that according to the above-described embodiments can be achieved.

In the cover 125, the groove (recess) may be formed in the end portion 1271 of the rib 127, instead of or in addition to the groove 822.

In the cover 135, the groove (recess) may be formed in the end portion 136, instead of or in addition to the groove 823.

### Sixth Embodiment

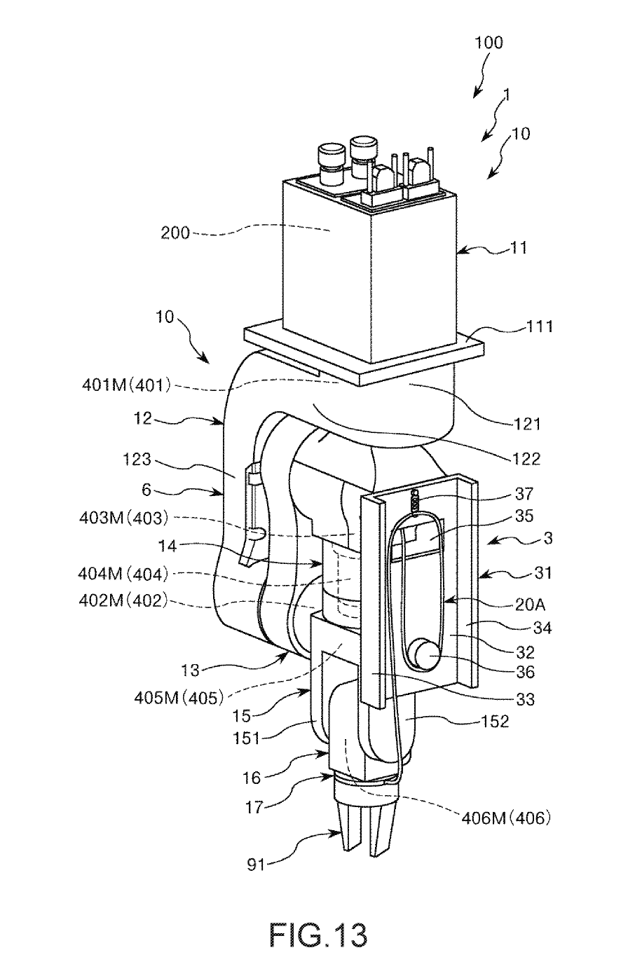

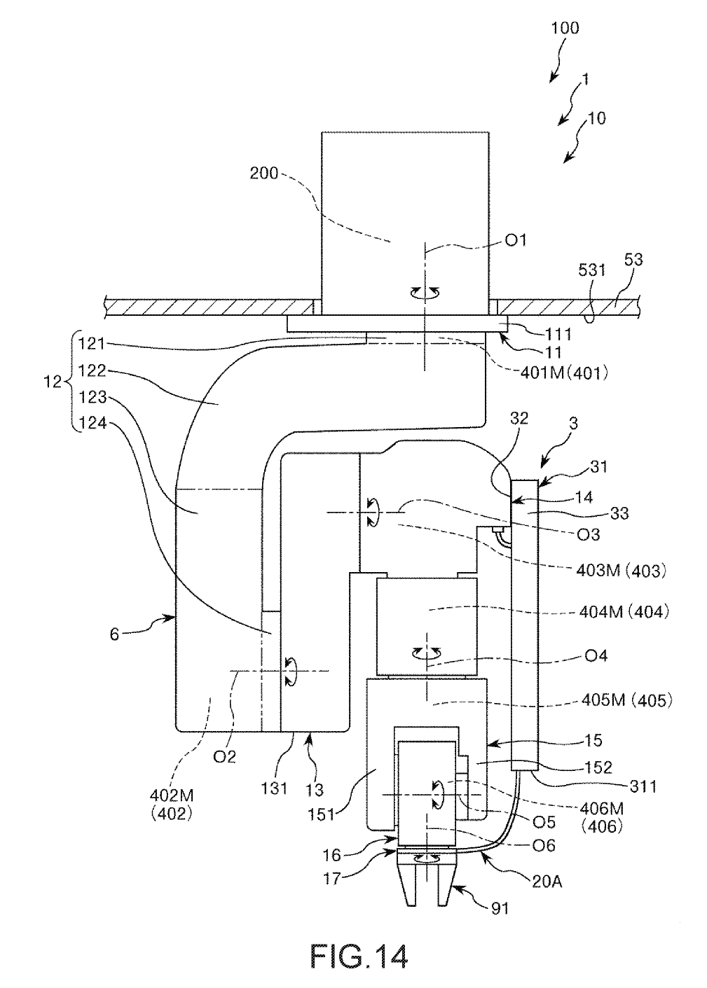

FIG. 13 is a perspective view illustrating a sixth embodiment of the robot (robot system) according to the invention. FIG. 14 is a side view of the robot illustrated in FIG. 13.

Hereinafter, for convenience of description, the upper side in FIGS. 13 and 14 will be referred to as “up” or “upward”, and the lower side will be referred to as “down” or “downward”. The right side will be referred to as “right”, and the left side will be referred to as “left”.

Hereinafter, the sixth embodiment will be described. However, points different from those in the above-described embodiments will be mainly described, and description of similar elements will be omitted.

As illustrated in FIGS. 13 and 14, in the robot 1 according to the present embodiment, the robot arm 6 has the third arm 14 disposed in the second arm 13 so as to be pivotable around the third pivot axis O3. The robot 1 includes a guide portion 3 disposed in the third arm 14 and guiding a cable 20A internally having wires (not illustrated). In this manner, in a case where the robot arm 6 is driven, it is possible to restrain the cable 20A (wire) from being caught on the robot arm 6. Hereinafter, the description will be made in more detail.

First, in the present embodiment, the robot 1 has the non-contact seal structure portion 7 according to any of the first to fifth embodiments described above.

As illustrated in FIGS. 13 and 14, the robot 1 has the cable 20A internally having a plurality of wires (electric wires, not illustrated) as elongated flexible members.

The hand 91 serving as an example of the end effector is disposed in the distal end of the robot arm 6, and the cable 20A (wire) is electrically connected to the hand 91 (end effector). In this manner, the control device 200 can control the driving of the hand 91.

Specifically, the cable 20A is used for an external wire, and electrically connects the control device 200 and the hand 91 (end effector) to each other via the above-described cable 20 and the sixth arm 17. The distal end portion (one end portion) of the cable 20A is electrically connected to a terminal (not illustrated) disposed in the sixth arm 17, and the proximal end portion (the other end portion) is electrically connected to a terminal (not illustrated) disposed in the third arm 14. The hand 91 is electrically connected to a terminal disposed in the sixth arm 17, and the control device 200 is electrically connected to a terminal disposed in the third arm 14 via the cable 20. The wire according to the invention includes the wire inside the cable 20 and the wire inside the cable 20A.

The robot 1 includes the guide portion 3 which guides the cable 20A (wire). The guide portion 3 is disposed in the third arm 14. In a case where the guide portion 3 is not disposed therein, if the robot arm 6 is driven and the fourth arm 15 pivots, the cable 20A is wrapped around the third arm 14 and the fourth arm 15, thereby causing a possibility that the cable 20A is interposed between the second arm 13 and the third arm 14 or between the second arm 13 and the fourth arm 15. However, the guide portion 3 can restrain the cable 20A from being caught on the robot arm 6. Hereinafter, the guide portion 3 will be described.

The guide portion 3 has a guide portion body 31 and a coil spring 37 serving as an example of an elastic member disposed in the guide portion body 31. The coil spring 37 is a configuration element of the guide portion 3 in the present embodiment. However, the coil spring 37 may be excluded from the configuration element of the guide portion 3.

Next, the guide portion body 31 will be described.

First, the robot arm 6 has the fourth arm 15 disposed in the third arm 14 so as to be pivotable around the fourth pivot axis O4. The axial direction of the fourth pivot axis O4 is orthogonal to (different from) the axial direction of the third pivot axis O3. The guide portion body 31 (guide portion 3) has a substrate 32 serving as an example of a plate-shaped portion disposed along the fourth pivot axis O4. In this manner, in a case where the robot arm 6 is driven, the cable 20A (wire) can be more accurately restrained from being caught on the robot arm 6.

Specifically, the guide portion body 31 has the substrate 32 and a pair of wall portions 33 and 34. The guide portion 3 is fixed to the third arm 14. In this case, the guide portion 3 is disposed on a side of the third arm 14 opposite to the second arm 13, and the upper side end portion of the substrate 32 is fixed to a portion of the third arm 14 opposite to the second arm 13. The guide portion body 31 (substrate 32) is disposed along the fourth pivot axis O4.

A shape of the substrate 32 is not particularly limited. However, in the present embodiment, the substrate 32 has a rectangle (quadrangle) shape in a plan view of the substrate 32. The wall portions 33 and 34 are disposed on two long sides of the rectangle shape (substrate 32). The wall portions 33 and 34 protrude in the direction orthogonal to (intersecting) the substrate 32. The wall portions 33 and 34 can restrain the cable 20A from laterally bulging out from the guide portion body 31.

A hole 35 penetrating the substrate 32 is formed in the upper side end portion of the substrate 32, and the cable 20A is inserted into the hole 35. A shape of the hole 35 is not particularly limited. However, in the present embodiment, the hole 35 has a rectangular (square) shape.

The coil spring 37 is disposed above the hole 35, in the upper side end portion of the substrate 32. The upper side end portion the coil spring 37 is attached to the substrate 32, and an intermediate portion of the cable 20A is attached to (supported by) the lower side end portion. The coil spring 37 biases the cable 20A upward. In this manner, it is possible to restrain the cable 20A from being unexpectedly moved. In an initial state of the robot 1 (posture illustrated in FIGS. 13 and 14), the coil spring 37 is brought into a natural state where no external force is applied thereto, or into a slightly stretched state.

A projection 36 is formed in the lower side end portion of the substrate 32. A shape of the projection 36 is not particularly limited. However, in the present embodiment, the projection 36 has a cylindrical shape. An intermediate portion of the cable 20A is hung on the projection 36.

A dimension of the projection 36 is not particularly limited, and is appropriately set depending on various conditions. However, a radius of the projection 36 is set to be equal to or larger than an allowable bending radius of the cable 20A.

In the present embodiment, the cable 20A is not only hung on the projection 36 but also fixed to the projection 36. However, the cable 20A may not be fixed thereto. A portion of the projection 36 may be configured to function as the coil spring 37. That is, instead of the projection 36, a coil spring (not illustrated) serving as an example of an elastic member may be disposed, and the cable 20A may be attached to the coil spring.

A dimension of the guide portion body 31 (guide portion 3) is not particularly limited, and is appropriately set depending on various conditions.

In the present embodiment, in a posture of the robot arm 6 illustrated in FIG. 14 where the first arm 12, the second arm 13, and the third arm 14 overlap each other when viewed in the axial direction of the second pivot axis O2, a lower end 311 of the guide portion body 31 is located below a lower end 131 of the second arm 13. In this manner, in a case where the robot arm 6 is driven, the cable 20A can be more accurately restrained from being caught on the robot arm 6.

An arrangement of the cable 20A is as follows.

The cable 20A is disposed outside the robot arm 6 from the third arm 14 to the sixth arm 17. Specifically, from the third arm 14 side toward the sixth arm 17 side, the cable 20A is inserted into the hole 35, and is disposed toward the projection 36 along the surface of the substrate 32. The cable 20A is hung on the projection 36, and is disposed toward the coil spring 37 along the surface of the substrate 32. The cable 20A is supported by the coil spring 37, and is disposed toward the sixth arm 17 along the surface of the substrate 32.

Next, an operation of the guide portion 3 will be described.

First, the cable 20A (wire) is supported by the coil spring 37 (elastic member) disposed in the guide portion 3. Therefore, if the robot arm 6 is driven and the fourth arm 15 pivots, the distal end portion of the cable 20A is pulled by the sixth arm 17, and the coil spring 37 is stretched (elastically deformed). In this manner, the coil spring 37 biases the cable 20A upward. The coil spring 37 is stretched after following the movement of the cable 20A. In this manner, the driving of the robot arm 6 can be restrained from being hindered by the cable 20A, or the cable 20A can be restrained from being broken.

Next, if the fourth arm 15 pivots in the opposite direction, a portion supported by the coil spring 37 of the cable 20A moves upward due to a restoring force (biasing force) of the coil spring 37. In this manner, the cable 20A can be restrained from being bent. Accordingly, the cable 20A can be restrained from laterally bulging out from the guide portion body 31.

According to the sixth embodiment as described above, an advantageous effect the same as that according to the above-described embodiments can be achieved.

In the present embodiment, the robot arm 6 has the guide portion 3. Accordingly, in a case where the robot arm 6 is driven, the cable 20A can be restrained from being caught on the robot arm 6.

Since the guide portion 3 is disposed on the side of the third arm 14 or the fourth arm 15 opposite to the second arm 13, that is, only on one side. Accordingly, compared to a case where the guide portion 3 is disposed over the entire periphery of the third arm 14 or the fourth arm 15, the robot 1 is advantageously decreased in size. It is possible to easily and quickly carry out work for attaching the guide portion 3 to the robot arm 6.

### Seventh Embodiment

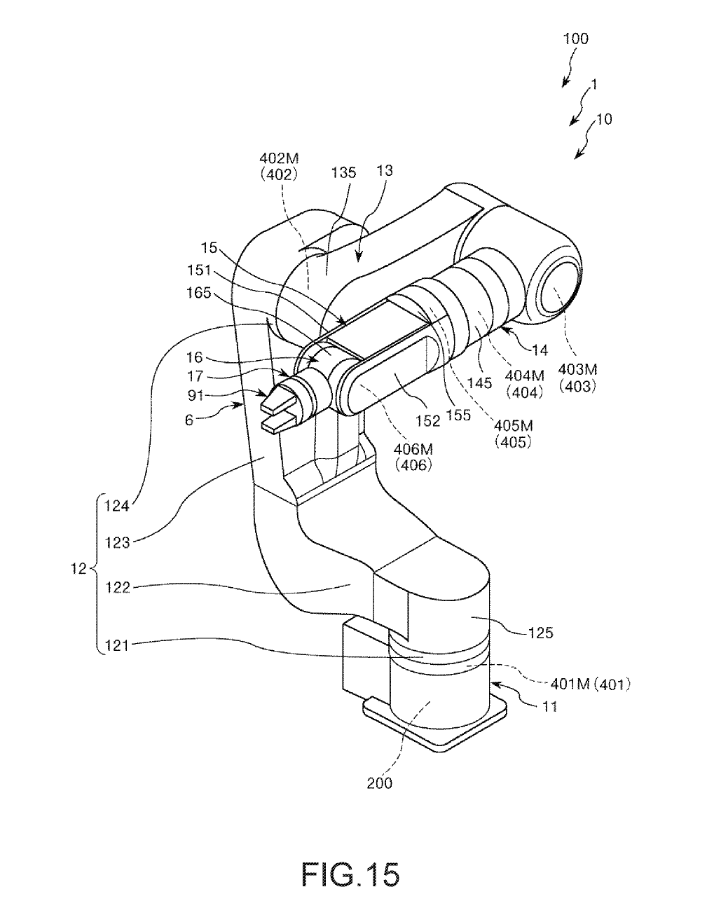

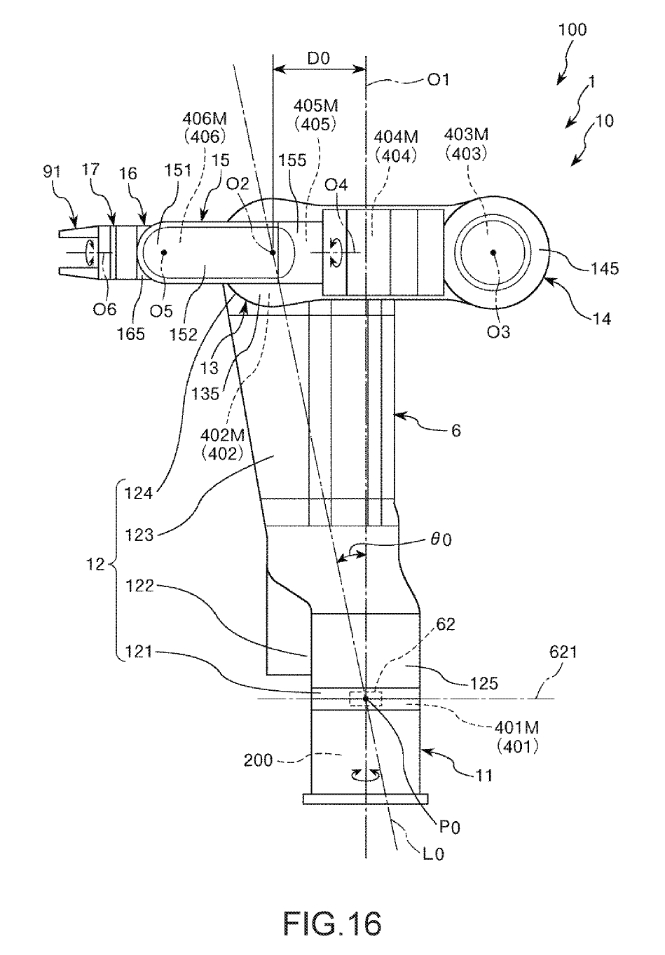

FIG. 15 is a perspective view illustrating a seventh embodiment of the robot according to the invention. FIG. 16 is a front view of the robot illustrated in FIG. 15.

Hereinafter, the seventh embodiment will be described. However, points different from those in the above-described embodiments will be mainly described, and description of similar elements will be omitted.

As illustrated in FIGS. 15 and 16, in the robot 1 according to the present embodiment, the base 11 is fixed to a floor (not illustrated) of the installation space.

The left side surface in FIG. 16 of the third portion 123 of the first arm 12 is inclined. The second pivot axis O2 and the first pivot axis O1 are in a twisted position. Therefore, the second pivot axis O2 is separated from the first pivot axis O1 as far as a distance DO when viewed in the axial direction of the second pivot axis O2. In this manner, an access to the side of the robot 1 and the installation surface side (base 11 side) of the robot 1 can be particularly facilitated. Therefore, the robot 1 can be used for various types of work depending on the usage or the purpose.

When viewed in the axial direction of the second pivot axis O2, a connection surface (connection portion) between the first arm 12 and the base 11, that is, an intersection between a center line 621 of the bearing portion 62 and the first pivot axis O1 is set to an intersection P0. When a line segment connecting the intersection P0 and the second pivot axis O2 is set to a line segment L0, an angle θ0 formed between the line segment L0 and the first pivot axis O1 is not particularly limited. However, the angle θ0 is preferably larger than 0° and smaller than 45°, and more preferably larger than 5° and smaller than 30°. In this manner, the robot arm 6 can be stably operated. While avoiding the interference with the robot 1 itself (for example, the base 11 or the first arm 12) or the peripheral device, the robot 1 can widen a range in which the distal end of the hand 91 (the distal end of the robot arm 6) is movable on the side of the robot 1 and in the vicinity of the base 11.

According to the seventh embodiment as described above, an advantageous effect the same as that according to the above-described embodiments can be achieved.

Hitherto, the robot according to the invention has been described with reference to the illustrated embodiments. However, the invention is not limited thereto. The respective configurations can be replaced with any desired configurations having the same function. Alternatively, any other desired configuration elements may be added thereto.

The invention may be embodied in combination of any desired two or more configurations (characteristics) of the above-described embodiments.

In the above-described embodiments, a case has been described where n defined in the appended claims is 1. However, the invention is not limited thereto, and n may be an integer of 1 or greater. That is, in the invention, as long as n is any desired integer greater than or equal to 1, a configuration may be adopted in the same way as the case where n is 1.

In the above-described embodiments, the number of pivot axes of the robot arm is six. However, the invention is not limited thereto. For example, the number of pivot axes of the robot arm may be two, three, four, five, seven or more. That is, in the above-described embodiment, the number of arms (links) is six. However, the invention is not limited thereto. For example, the number of arms may be two, three, four, five, seven or more. For example, in the robot according to the above-described embodiments, an arm is added between the second arm and the third arm. In this manner, a robot having seven arms can be realized.

In the above-described embodiments, the number of robot arms is one. However, the invention is not limited thereto. For example, the number of robot arms may be two or more. That is, for example, the robot (robot body) may be a multi-arm robot such as a dual arm robot.

In the above-described embodiments, an example has been described in which the hand is employed as the end effector. However, the invention is not limited thereto. The end effector includes a drill, a welding machine, and a laser irradiation machine.

In the above-described embodiments, the fixed location of the robot is the ceiling or the floor. However, the invention is not limited thereto. For example, the fixed location of the robot includes a wall in the installation space, a work table, and the ground. The robot may be installed inside a cell. In this case, the fixed location of the base is not particularly limited. For example, the fixed location of the base includes the ceiling portion of the cell, the wall portion, the work table, and the floor portion.

In the above-described embodiments, the surface to which the robot (base) is fixed is a plane (surface) parallel to the horizontal plane. However, the invention is not limited thereto. For example, the invention may employ a plane (surface) inclined with respect to the horizontal plane or the perpendicular plane, or may employ a plane (surface) parallel to the perpendicular plane. That is, the first pivot axis may be inclined with respect to the perpendicular direction or the horizontal direction. Alternatively, the first pivot axis may be parallel to the horizontal direction.

In the invention, the robot may employ other types (forms). For example, specific examples include a horizontal articulated robot and a legged walking (running) robot having leg portions. The “Horizontal articulated robot” means a robot in which the arm (excluding a spline shaft) is operated in the horizontal direction.

The entire disclosure of Japanese Patent Application No. 2017-029699, filed Feb. 21, 2017 is expressly incorporated by reference herein.

What is claimed is:

1. A robot comprising:
a robot arm that has an nth arm (n is an integer of 1 or greater) and an (n+1)th arm disposed in the nth arm so as to be pivotable around an (n+1)th pivot axis; and
a motor that drives the (n+1)th arm,
wherein each of the nth arm and the (n+1)th arm has a cover,
wherein a wire is disposed between the motor and the cover of the nth arm, and
wherein a non-contact seal structure is formed using the cover of the nth arm and the cover of the (n+1)th arm.

2. The robot according to claim 1,
wherein the non-contact seal structure is a labyrinth structure.

3. The robot according to claim 1,
wherein the non-contact seal structure has a gap formed between the cover of the nth arm and the cover of the (n+1)th arm, and
wherein in a cross section taken along the (n+1)th pivot axis, the gap has a first gap which extends in a direction intersecting an axial direction of the (n+1)th pivot axis and a second gap which extends in a direction intersecting the extending direction of the first gap and which communicates with the first gap.

4. The robot according to claim 1,
wherein at least any one of the cover of the nth arm and the cover of the (n+1)th arm has a recess which is recessed in the direction intersecting the axial direction of the (n+1)th pivot axis.

5. The robot according to claim 4,
wherein the recess is located inside the non-contact seal structure.

6. The robot according to claim 1,
wherein the non-contact seal structure internally has a grease.

7. The robot according to claim 6,
wherein a worked penetration of the grease is in a range from 150 to 300.

8. The robot according to claim 1,
wherein the non-contact seal structure internally has an absorbing material capable of absorbing a grease.

9. The robot according to claim 1,
wherein the nth arm is pivotable around an nth pivot axis (n is an integer of 1 or greater),
wherein the axial direction of the (n+1)th pivot axis is different from the axial direction of the nth pivot axis, and
wherein when viewed in the axial direction of the (n+1)th pivot axis, the nth arm and the (n+1)th arm overlap each other.

10. The robot according to claim 1,
wherein a length of the nth arm is longer than a length of the (n+1)th arm.

11. The robot according to claim 1,
wherein the nth arm (n is 1) is disposed in a base.

12. The robot according to claim 1,
wherein the robot arm has an (n+2)th arm which is disposed in the (n+1)th arm so as to be pivotable around an (n+2)th pivot axis, and
wherein the robot arm has a guide disposed in the (n+2)th arm so as to guide the wire.

13. The robot according to claim 11,
wherein an end effector is disposed in a distal end of the robot arm, and
wherein the wire is electrically connected to the end effector.

14. The robot according to claim 12,
wherein the wire is supported by a coil spring disposed in the guide.

15. The robot according to claim 12,
wherein the robot arm has an (n+3)th arm disposed in the (n+2)th arm so as to be pivotable around an (n+3)th pivot axis,
wherein the axial direction of the (n+3)th pivot axis is different from the axial direction of the (n+2)th pivot axis, and
wherein the guide portion has a plate-shaped portion disposed along the (n+3)th pivot axis.
